(19) United States
(12) Patent Application Publication
(10) Pub. No.: US 2017/0265435 A1
(43) Pub. Date: Sep. 21, 2017

(54) VIBRATORY PET TOY

(71) Applicant: Worldwise, Inc., Novato, CA (US)

(72) Inventors: Michael Risso, Napa, CA (US); Charles Floyd, Oakland, CA (US)

(21) Appl. No.: 15/072,114

(22) Filed: Mar. 16, 2016

(51) Int. Cl. A01K 15/02

(52) U.S. Cl. CPC A01K 15/025

(57) ABSTRACT

A vibratory pet toy having a substantially spherical shell with a top and bottom, the bottom having a circular opening. The toy includes a platform being in the form of a circular disc having a disk top, disk bottom and disk circumference sized to fit within and be retained by the circular opening. A plurality of flexible legs are evenly spaced about the disk circumference and extend outwardly of the spherical shell from the disk bottom and a rotational motor positioned within the spherical shell including an eccentric load rotatable by the rotational motor. A power supply for selectively activating the rotational motor completes the toy.

### TECHNICAL FIELD

The present invention is directed to a pet toy specifically intended to be of interest to domestic cats. The toy emits a buzzing sound and moves haphazardly which cats find to be irresistible as a result of their curiosity and prey instinct.

### BACKGROUND OF THE INVENTION

It is well known that pets, and particularly cats, have certain instinctual needs which must be satisfied. Failure to do so can not only result in the expression of overt antisocial behavior but can even adversely affect the health and well-being of the animal. One of these needs is to chase a moving attractant and, in the vicinity of the attractant, to swipe and pounce upon it satisfying the cat's inherent need to hunt.

A cat's instinct to swipe and pounce upon a moving object is well known to virtually all cat owners. It is quite common to see a pet owner dangle an attractant such as a feathered bundle or plush mouse in a cat's vicinity to appreciate this instinctual behavior. Such toys also help to keep cats occupied and exercised while providing the pet's owner with the enjoyment of watching his or her cat at play.

Although there are a plethora of cat toys which have been designed to satisfy the cat's need to hunt, most are either overly complex, fail to achieve their intended objective or are subject to breakage.

There are a significant number of vibratory toys such as those disclosed in U.S. Pat. Nos. 8,038,503, 8,591,281, 8,834,226; 8,834,227, 8,882,558, 8,905,813, 9,017,136 and 9,050,541, all of which are related as having a common assignee. The vibration powered toys of the prior art, as exemplified by the cited patents, use rotational motors that spin a shaft attached to a counterweight. The rotation of the counterweight induces an oscillatory motion, which, in turn, causes the toy to vibrate and bounce along a support surface. Such toys are taught to have elongated bodies and “legs” arranged in rows on each side of their bodies, the legs being curved and off-set causing the toy to move in a linear path. Although such toys are capable of amusing a cat, their linear motion has been found to be less than ideal in satisfying the cat's need to hunt and pounce.

It is thus an object to the present invention to provide a vibratory pet toy which moves haphazardly, thus stimulating the cat's need to hunt and pounce.

It is yet a further object of the present invention to provide a vibratory pet toy which is substantially spherical in shape, capable of rolling, and in some instances self-righting to further encourage a cat to swipe and pounce as a form of amusement.

These and further objects will be more readily apparent when considering the following disclosure and appended claims.

### SUMMARY OF THE INVENTION

A vibratory pet toy comprising:

a substantially spherical shell having a top and bottom, said bottom having a substantially circular opening;

a platform being in the form of a substantially circular disc having a disk top, disk bottom and disk circumference sized to fit within and be retained by said substantially circular opening;

a platform of flexible legs, said flexible legs being substantially evenly spaced about said disk circumference and extending outwardly of said substantially spherical shell from said disk bottom;

a rotational motor positioned within said spherical shell and eccentric load rotatable by said rotational motor; and

a power supply for selectively activating said rotational motor.

### BRIEF DESCRIPTION OF THE FIGURES

FIG. 1 is a front perspective view of one embodiment of the vibratory pet toy the present invention.

FIG. 2 is a cross-sectional view of the vibratory pet toy of FIG. 1 taken along sectional line 2-2.

FIG. 3 is a bottom plan view of the vibratory pet toy of the present invention.

FIG. 4 is a front perspective view of a second embodiment of the vibratory pet toy the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods, and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

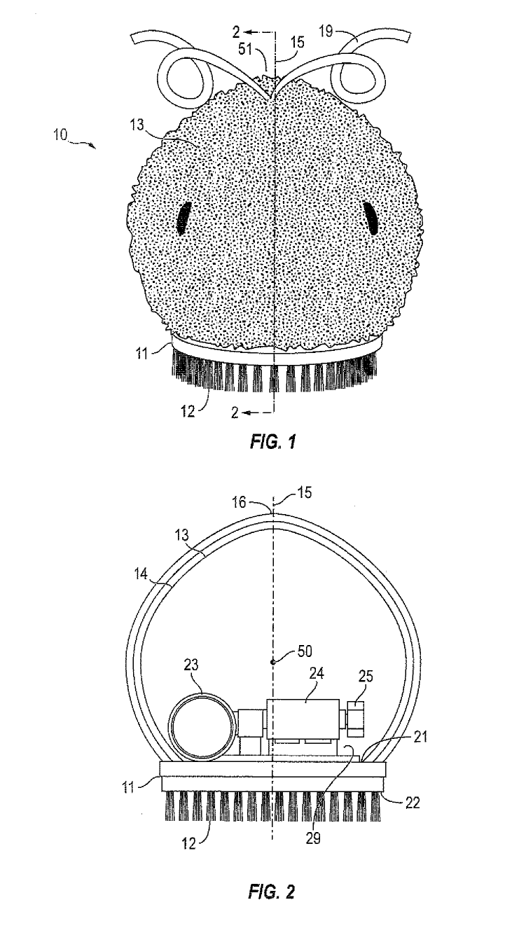

FIG. 1 depicts a first embodiment of vibratory pet toy 10 having plush fabric cover 13 and optional attractant 19. As shown in FIG. 2, which is a cross-sectional view of vibratory pet toy 10 taken along sectional line 2-2, plush cover 13 is fitted over substantially spherical shell 14, the latter being generally composed of plastic which is lightweight and yet somewhat resistant to abuse.

It is noted that substantially spherical shell 14 has substantially circular opening 29 at its bottom. A platform in the form of disc 11 is substantially circular having disk top 21, disk bottom 22 and disk circumference 26, the latter being sized to fit within and be retained by substantially circular opening 29.

A plurality of flexible legs 12 are substantially evenly spaced about disk circumference 26 and extend outwardly of the substantially spherical shell 14 from disk bottom 22. Ideally, flexible legs 12 comprise bundles of bristles having first ends extending from disk bottom 22 and second ends contacting a support surface for the vibratory toy. These bristles are characterized as being linear and devoid of curvature as they extend from disk to the recited support surface.

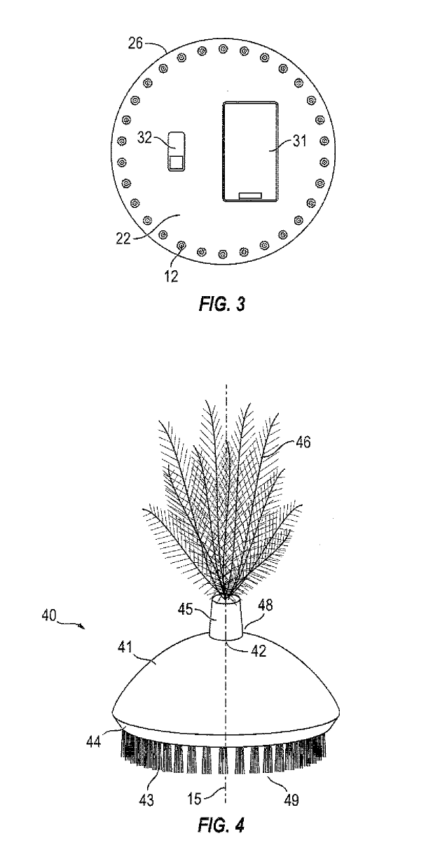

As noted, the present toy operates by vibration causing the toy to somewhat bounce from a support surface as the ends of bristles contact and rise from the surface. This is generally accomplished by providing rotational motor 24 positioned within spherical shell 14 joined to an eccentric load 25 rotated by rotational motor 24. Motor 24 can be powered by a suitable power supply 23, generally in the form of batteries. When batteries are employed, they can be accessed via closable latch 31 used to introduce fresh batteries as needed. Motor 24 can also be selectively activated by use of switch 32 also ideally accessed from bottom 22 of substantially circular disc 11 (FIG. 3).

In providing the vibratory toy as described above, a cat attractant is taught which not only vibrates but also turns and moves haphazardly. Such action is been found to be highly stimulating to a cat seeking to hunt and pounce instinctively. Being spherical in shape, the toy would also tend to roll which also enhances stimulation for as the cat swipes and pounces upon it, the toy will generally roll causing it to travel away from the cat resulting in the cat chasing it instinctively.

Although the center of gravity of the vibratory pet toy of FIG. 1 is proximate its bottom as the disc and supporting motor, counterbalanced weight and power supply are positioned as shown, as a cat swipes at the toy, it will often times roll as any spherical object would thus causing legs 12 to lose contact with one's floor or other support surface. However, to encourage vibratory toy 10 to self-upright, substantially spherical shell 14 having longitudinal axis 15 passing through the center of substantially circular opening 29 center 50 of substantially spherical shell 14 and the top 51 thereof is somewhat out of round resulting in protrusion 16 located proximate longitudinal axis 15 at top 51 as shown. This encourages vibratory pet toy 10, when swiped and rolling upon a support surface to self-upright so that legs 12 can re-engage the support surface causing vibratory pet toy 10 to reestablish its intended haphazard motion.

As a second embodiment, reference is made to FIG. 4 showing vibratory pet toy 40 having substantially spherical shell 41 having top 48 and bottom 49, bottom 49 having a circular opening for receiving disk 44 which is virtually identical to disk 11 of the embodiment of FIG. 1. As such, substantially spherical shell 41 is provided with an opening at bottom 49 sized to receive substantially circular disc 44 and further including a plurality of flexible legs 43 being substantially evenly spaced about the circumference of disk 44 and extending outwardly of substantially spherical shell 41 from the disc bottom. The same rotational motor, eccentric load rotatable by the rotational motor and power supply can be encased within substantially spherical shell 41 as depicted in FIG. 2 hereof.

To enhance the interest of the engaged pet, vibratory pet toy 40 is further characterized by spherical shell 41 which comprises an opening 42 proximate longitudinal axis 15 at top 48. Stem 45 is sized to fit within opening 48 and which can secure an attractant such as a leathered bundle 46. As vibratory toy 40 haphazardly vibrates and moves about a support surface, attractant 46 will also vibrate further encouraging the pet to swipe and pounce upon the toy. As a preferred embodiment, stem 45 and attractant 49 can be replaced as the attractant is degraded through use.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is

1. A vibratory pet toy comprising:
a substantially spherical shell having a top and bottom, said bottom having a substantially circular opening;
a platform being in the form of a substantially circular disc having a disk top, disk bottom and disk circumference sized to fit within and be retained by said substantially circular opening;
a plurality of flexible legs, said flexible legs being substantially evenly spaced about said disk circumference and extending outwardly of said substantially spherical shell from said disk bottom;
a rotational motor positioned within said spherical shell and eccentric load rotatable by said rotational motor; and
a power supply for selectively activating said rotational motor.

2. The vibratory pet toy of claim 1 wherein said legs comprise bundles of bristles, said bristles having first ends extending from said disk bottom and second ends contacting a support surface for said vibratory pet toy.

3. The vibratory pet toy of claim 1 wherein said substantially spherical shell is characterized as having a longitudinal axis passing between the center of said substantially circular opening, the center of said substantially spherical shell and the top of said substantially spherical shell.

4. The vibratory pet toy of claim 3 wherein said substantially spherical shell is further characterized as having a protrusion proximate said longitudinal axis at the top thereof.

5. The vibratory pet toy of claim 1 further comprising a plush fabric encasing said substantially spherical shell, said plush fabric open at said substantially circular opening.

6. The vibratory pet toy of claim 1 further comprising an on/off switch for selectively powering said rotational motor by said power supply, said on/off switch being accessible from said disk bottom.

7. The vibratory pet toy of claim 1 further comprising a removable latch for replacing said power supply through said substantially circular disc.

8. The vibratory pet toy of claim 3 wherein said substantially spherical shell further comprises an opening proximate said longitudinal axis at the top thereof.

9. The vibratory pet toy of claim 8 further comprising a stem sized to fit within said opening.

10. The vibratory pet toy of claim 8 further comprising an attractant supported by and emanating from said stem.

11. The vibratory pet toy of claim 2 wherein said bristles are characterized as being linear and devoid of curvature as they extend from said disk to a support surface for said pet toy.
